(19) United States
(12) Patent Application Publication
(10) Pub. No.: US 2019/0232581 A1
(43) Pub. Date: Aug. 1, 2019

(54) WIRE BUNDLE COATING APPARATUS AND METHOD

(71) Applicant: Lightning Technologies, LLC, Oxford, MI (US)

(72) Inventor: Jacob GABEL, Lapeer, MI (US)

(73) Assignee: Lightning Technologies, LLC, Oxford, MI (US)

(21) Appl. No.: 16/265,579

(22) Filed: Feb. 1, 2019

Related U.S. Application Data
(60) Provisional application No. 62/624,832, filed on Feb. 1, 2018.

(51) Int. Cl. B29C 70/68; H01R 43/18; B29C 67/24; B29C 70/70

(52) U.S. Cl. CPC B29C 70/681; H01R 43/18; B29L 2031/34; B29C 70/70; B29C 67/246

(57) ABSTRACT

An apparatus for selectively coating a portion of a wire bundle apparatus is provided. The apparatus includes a base member, a vertical member, a horizontal member, a clamp apparatus, and an attachment member. The horizontal member is mounted to the vertical member for translation between at least a first position and a second position. The clamp apparatus includes a lower die element mounted to the horizontal member and a lower die element mounted to the base member including a cavity. The attachment member includes wire cutouts and is mounted to the lower die element such that the wire cutouts are in substantial registration with the cavity. The wire cutouts are arranged with the cavity to separate wires of a wire apparatus disposed therein such that a coating material introduced within the cavity fully coats each of the wires when the horizontal member is in the second position.

### CROSS-REFERENCE TO RELATED APPLICATIONS

This application claims the benefit of U.S. provisional application Ser. No. 62/624,832 filed Feb. 1, 2018, the disclosure of which is hereby incorporated in its entirety by reference herein.

### TECHNICAL FIELD

The present disclosure relates to a wire bundle coating apparatus and method.

### BACKGROUND

Electrical devices use wires and connectors to facilitate signal and power transfer into and out of the electrical devices. Multiple wires are often connected to a single electrical device. These multiple wires may be bundled at a connection location to simplify apparatus. For example, vehicles use wire harnesses to group wires together and provide a connector to electrically connect the wires to a vehicle component. In operation, a connection location between the connector and wires may be subjected to environmental factors such as debris and water which may negatively impact electrical performance.

### SUMMARY

An embodiment of an apparatus for selectively coating a portion of a wire bundle is is provided having a base member, a vertical member, a horizontal member, a clamp apparatus, and an attachment member. The vertical member extends from the base member. The horizontal member is mounted to the vertical member for translation between at least a first position and a second position. The clamp apparatus includes a lower die element mounted to the horizontal member and a lower die element mounted to the base member including a cavity. The attachment member includes wire cutouts and is mounted to the lower die element such that the wire cutouts are in substantial registration with the cavity. The wire cutouts are arranged with the cavity to separate wires of a wire apparatus disposed therein such that a coating material introduced within the cavity fully coats each of the wires when the horizontal member is in the second position.

In an alternative embodiment, a coating application apparatus includes a base member, a vertical member, a horizontal member, a clamp apparatus, and an attachment. The vertical member extends from the base member. The horizontal member is mounted to the vertical member for translation between at least a first position and a second position. The clamp apparatus includes a lower die element mounted to the horizontal member and a lower die element mounted to the base member having a first cavity sized to receive a portion of a wire bundle including wires. The attachment is mounted to the lower die element and includes a plurality of wire cutouts each sized to receive one of the wires and separate each of the wires from one another. The lower die element defines a channel to facilitate delivery of a coating material to the first cavity such that the coating material encompasses each of the plurality of wires to create a hermetic seal at a connection location adjacent an electrical connector when the horizontal member is in the second position.

In another alternative embodiment of an apparatus for selectively coating an end portion of a wire bundle attached to an electrical connector is provided. The apparatus has a first and a second die element defining a mold cavity therebetween when closed. The mold cavity is sized to receive an electrical connector and the end portion of a wire bundle attached to an electrical connector end. At least one attachment member is affixed to one of the first and second die elements providing a plurality of wire cutouts each sized to receive the wire bundle and separate each of the wires from one another. One of the first and a second die elements is provided which an inlet for introducing a moldable polymeric material into the mold cavity, the mold cavity has three regions. A first encapsulation cavity region surrounds an attachment portion of the electrical connector into which moldable polymeric material is introduced. A second conductor region sized to receive a conductor portion of the electrical connector and the affixed ends of the wire bundle into which moldable polymeric material does not flow. A third attachment region formed by the at least one attachment member which restricts the flow of moldable polymeric material out of the mold cavity about the wire bundle.

A method is disclosed to selectively coat portions of a plurality of wires includes positioning a wire harness apparatus including a plurality of wires within a cavity of a lower die element of a clamp apparatus such that each of the plurality of wires is separated from one another by being positioned within one of a plurality of wire cutouts of an attachment member mounted to the first element. The method further includes actuating a lower die element of the clamp apparatus to compress against the first element. The method further includes introducing a coating material to the cavity via a helix channel while heating a first heater block of the lower die element to a first predetermined temperature and heating a second heater block of the lower die element to a second predetermined temperature. The coating material is mixed while traveling through the helix channel and subjected to the first predetermined temperature and the second predetermined temperature such that the coating material solidifies about each of the plurality of wires to create a hermetically sealed mold.

An alternative method embodiment is also provided for selectively coating the end portions of a plurality of wires attached to an electrical connector. The method comprises providing a first and a second die element defining a mold cavity therebetween when closed. The mold cavity is sized to receive an electrical connector and the end portion of a wire bundle attached to an electrical connector end. The electrical connector attached to the end portion of a wire bundle into the mold cavity is introduced into the mold. The wires in the wire bundle are positioned in a plurality of wire cutouts in an attachment member connected to one of the die elements with the cutouts sized to receive the wires forming the wire bundle. A conductor region of the electrical connector is attached to a conductor portion of the mold cavity. The mold is closed and a flowable polymeric material is introduced into an encapsulation cavity portion of the mold cavity to surround the end portion of a wire bundle and an attachment region of the electrical connector. The polymeric material is restricted from flowing into the conductor portion of the mold cavity or past the wires held in the attachment member. After the polymeric material has solidified, opening the mold cavity and removing the encapsulated electrical connector attachment region and end portion of a wire bundle.

### BRIEF DESCRIPTION OF THE DRAWINGS

FIG. 1 is a perspective view of an example of an apparatus to form molds for wire harness assemblies.

FIG. 2 is a perspective view of a portion of the apparatus of FIG. 1.

FIG. 3 is a perspective view of an example of a lower die element of the apparatus of FIG. 1.

FIG. 4 is a top plan view of the lower die element of the apparatus of FIG. 3.

FIG. 5 is a side view, in cross-section, of a portion of the lower die element of FIG. 3.

FIG. 6 is a front view of the lower die element of FIG. 3.

FIG. 7 is a perspective view of the upper die element.

FIG. 8 is a bottom plan view of the upper die element of FIG. 7.

FIG. 9 is a side view, in cross-section, of a portion of the upper die element of FIG. 7.

FIG. 10 is a front view, of the upper die element of FIG. 7.

FIG. 11 is an elevated perspective view of the lower die element of FIG. 3 shown with an example of a wire bundle placed thereupon.

FIG. 12 is a perspective view of a portion of the lower die element of FIG. 3 shown with an attachment member mounted thereto and the wire bundle of FIG. 11 resting within a cavity and upon a connector mount.

FIG. 13 is a front perspective view of an example of a upper attachment member of the apparatus of FIG. 1.

FIG. 14 is a rear perspective view of the upper attachment member of FIG. 13.

FIG. 15 is a rear side view of the upper attachment member of FIG. 13.

FIG. 16 is a first perspective view of an example of a lower attachment member of the apparatus of FIG. 1.

FIG. 17 is a second perspective view of the lower attachment member of FIG. 16.

FIG. 18 is a top plan view of the lower attachment member of FIG. 16.

FIG. 19 is a perspective view of the wire bundle of FIG. 11 shown with a mold formed over a portion of the wire bundle.

FIG. 20 is a top plan view of another example of a lower die element of the apparatus of FIG. 1 having a helical insert in the input channel.

FIG. 21 is a top plan view of yet another example of a lower die element of the apparatus of FIG. 1 in which the lower die element includes a helical channel and a slider.

FIG. 22 is a flow chart of an example of a method to mold a plastic layer encapsulating portions of a wire harness apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ embodiments of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

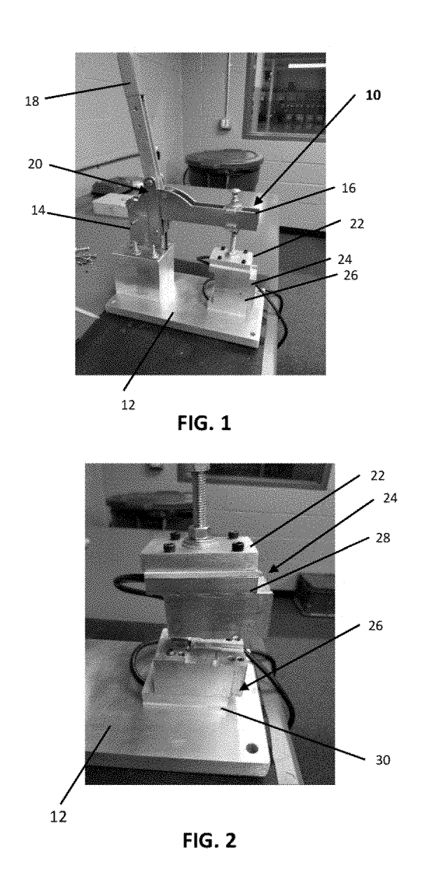

FIG. 1 illustrates a perspective view of an example of an apparatus 10. The apparatus includes a base platform 12, a vertical member 14, a horizontal member 16, a handle 18, and a toggle clamp 20. The vertical member 14 and the toggle clamp 20 extend from the base platform 12. The horizontal member 16 extends from the vertical member 14 and is mounted thereto for translation between at least a first position (FIG. 1) and a second position (FIG. 2). The handle 18 is pivotally mounted to the vertical member 14 and the horizontal member 16 to direct the translation of the horizontal member 16. The clamp plate 22 is coupled to the horizontal member 16 such that movement of the handle 18 of the toggle clamp 20 directs an upper die element of the clamp plate 22 to compress against a lower die element of the clamp plate 22.

For example, FIG. 2 illustrates further detail of the clamp plate 22. The clamp plate 22 is connected to an upper die element 24 and a lower die element 26. The upper die element 24 translates between a disengaged position (FIG. 2) and an engaged position (FIG. 1). The upper die element 24 may include a first heater block 28. The lower die element 26 may include a second heater block 30. Each of the heather blocks may include a controllable heat element to operate at various temperatures. Each of the heat elements may be electrically connected to a controller and a power source. For example, a controller may direct the heat elements to operate at predetermined temperatures and may direct the power source to supply power to the heat elements to facilitate operation. The first heater block 28 and the second heater block 30 may be arranged with one another to apply heat to a component located between the upper die element 24 and the lower die element 26 when oriented in the engaged position. For example, the heat may be applied at a temperature between 125° C. and 175° C. for a time-period of between eight and thirty seconds.

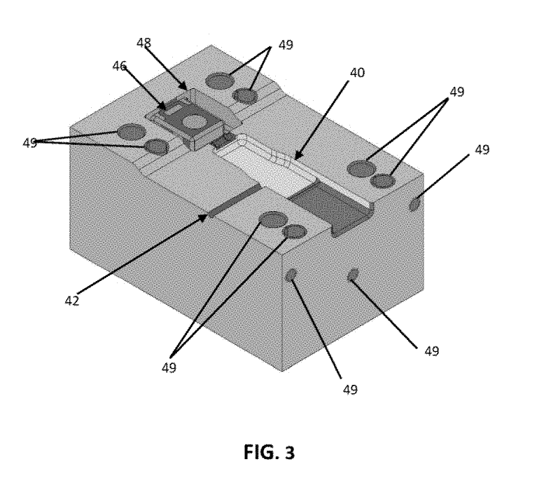

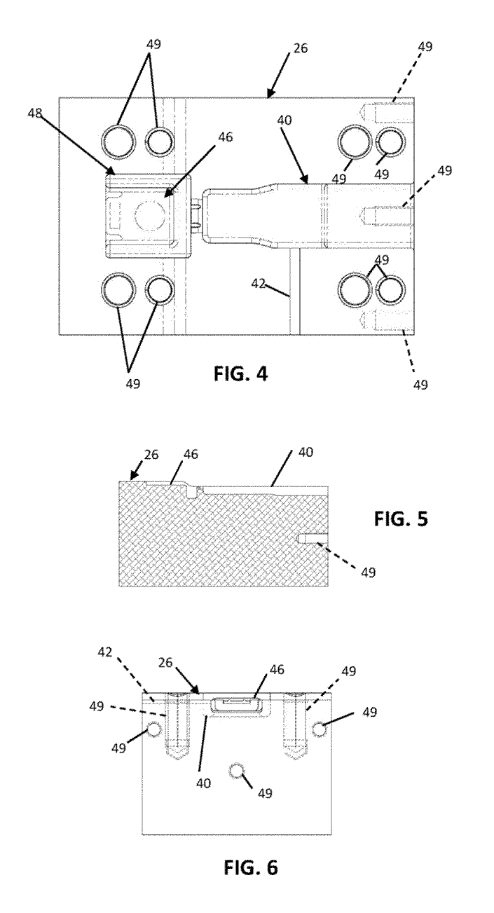

FIGS. 3 through 6 illustrate an example of a configuration of the lower die element 26. In this example, the lower die element 26 includes a first cavity 40, a first channel 42, and a connector mount 46. The first channel 42 is open to the first cavity 40 to assist in delivering materials, such as a coating material, to the first cavity 40. The first cavity 40 may be sized to receive a portion of a wire bundle. In one example, the first cavity 40 may have a depth between one and three millimeters relative to a surface of the lower die element 26. The connector mount 46 may be sized for resting an electrical connector thereupon. Examples of electrical connectors include an eyelet, a multi-wire centralized ground cable, a splice, a multi-wire terminal, and a connector requiring a water proof seal or an anti-capillary seal. A trench 48 may extend about the connector mount 46 to receive a portion of an electrical connector resting thereupon. The first cavity 40 and the connector mount 46 may be arranged with one another such that a first portion of wires of a wire harness apparatus rests within the first cavity 40 and an electrical connector of the wire harness apparatus rests upon the connector mount 46. The lower die element 26 may include one or more receiving apertures 49 to receive fasteners to mount other components thereto.

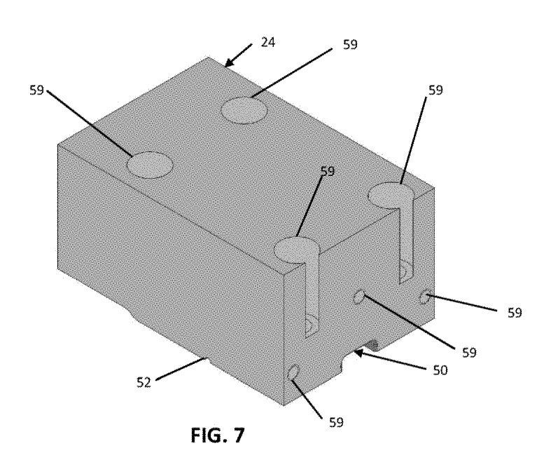

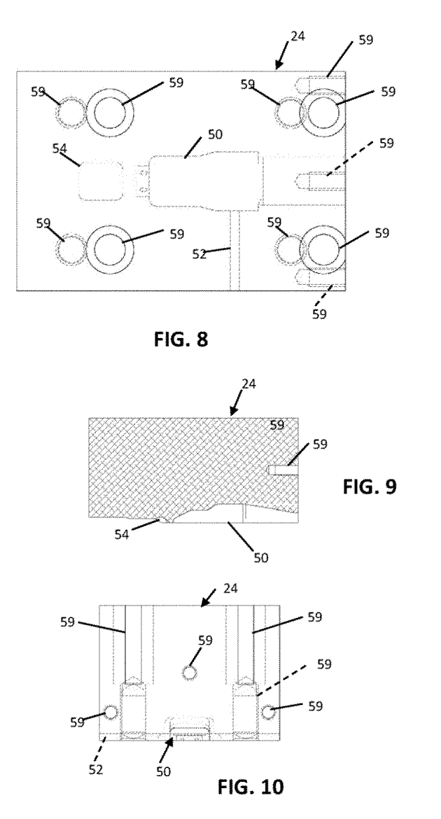

FIGS. 7 through 10 illustrate an example of a configuration of the upper die element 24. The upper die element 24 may include a second cavity 50, a second channel 52, and a connector cavity 54. The second channel 52 is open to the second cavity 50 to assist in delivering materials, such as a coating material, to the second cavity 50. The second cavity 50 may be oriented upon the upper die element 24 and sized to receive another portion of wires of the wire harness apparatus. In one example, the second cavity 50 may have a depth between one and three millimeters relative to a surface of the upper die element 24. The connector cavity 54 may be sized to receive a portion of the electrical connector of the wire harness apparatus described above. The upper die element 24 and the lower die element 26 may be arranged with one another so that the first cavity 40 aligns with the second cavity 50, the first channel 42 aligns with the second channel 52, and the connector mount 46 aligns with the connector cavity 54 when the upper die element 24 and the lower die element 26 are in the engaged position. Further, surfaces of the upper die element 24 and the lower die element 26 may be shaped to facilitate a flush relationship therebetween when the elements are in the engaged position. The upper die element 24 may include one or more receiving apertures 59 to receive fasteners to mount other components thereto.

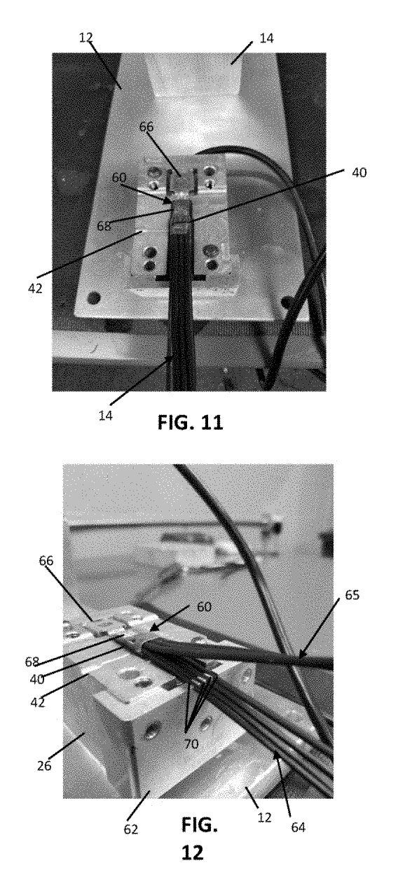

FIGS. 11 and 12 illustrate an example of a wire bundle apparatus 60 removably mounted to the lower die element 26 and illustrate an example of a first attachment member 62. The wire bundle apparatus 60 includes a first plurality of wires 64, a second plurality of wires 65, an electrical connector 66, and a housing 68 at a connection location between the wires and the electrical connector 66. The first plurality of wires 64 and the second plurality of wires 65 may be arranged with one another in a multi-tier orientation. The first attachment member 62 may assist in separating the wires from one another to apply a coating thereabout. For example, the first attachment member 62 may be mounted to the lower die element 26 so that a plurality of wire cutouts 70 are in substantial registration with the first cavity 40 and such that a portion of the wire bundle apparatus 60 may be positioned within the first cavity 40 and each of the wires of the first plurality of wires 64 may be positioned within one of the wire cutouts 70. In one example, the wire cutouts 70 may be arranged with one another to define a comb shape to orient the wires to provide space for material to flow around the wires to ensure a complete seal thereabout.

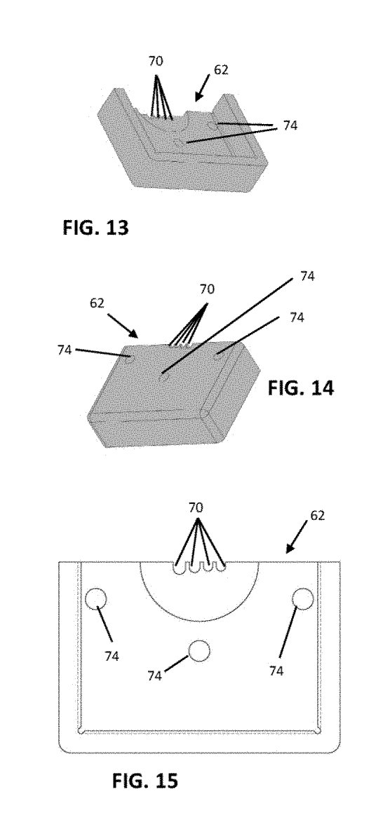

FIGS. 13 through 15 illustrate an example of the first attachment member 62 for mounting to the lower die element 26. While the first attachment member 62 is shown with four wire cutouts 70, it is contemplated that the first attachment member 62 may have various numbers of wire cutouts 70 based on a type of wire harness apparatus selected. The wire cutouts 70 may be of a same material as the lower die element 26 or of a malleable material. Additionally, the wire cutouts 70 may be a combination of metal alloy, silicone rubber, non-marring composite plastic, or Teflon to further assist in positioning each of the first plurality of wires 64 within one of the wire cutouts 70. The first attachment member 62 may have one or more receiving apertures 74 to receive fasteners for mounting the first attachment member 62 to the lower die element 26.

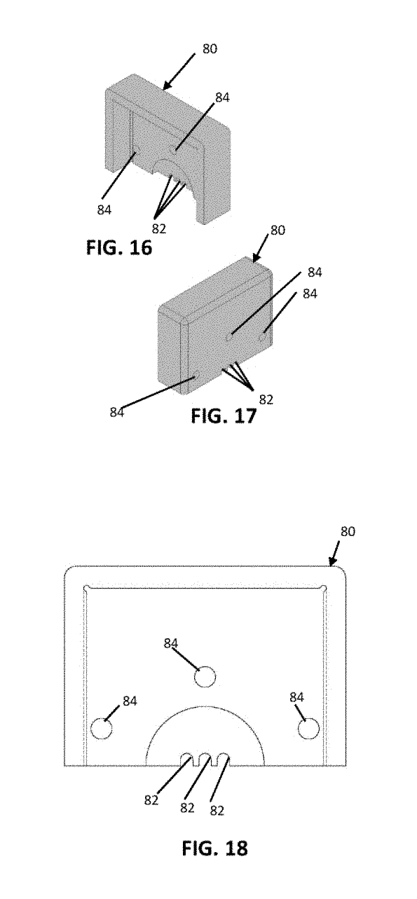

FIGS. 16 through 18 illustrate an example of a second attachment member 80 for mounting to the upper die element 24. While the second attachment member 80 is shown with three wire cutouts 82, it is contemplated that the second attachment member 80 may have various numbers of wire cutouts 82 based on a type of wire harness apparatus selected. The second attachment member 80 may be mounted to the upper die element 24 so that the plurality of wire cutouts 82 are in substantial registration with the second cavity 50 and such that a portion of the wire bundle apparatus 60 may be positioned within the second cavity 50 and each of the wires of the second plurality of wires 65 may be positioned within one of the wire cutouts 82. The wire cutouts 82 may be of a same material as the upper die element 24 or may be one or more of a metal alloy, a silicone rubber, a non-marring composite plastic, and a Teflon material to further assist in positioning each of the second plurality of wires 65 within one of the wire cutouts 82. The wire cutouts 82 may be arranged with one another to define a comb shape.

The second attachment member 80 may have one or more receiving apertures 84 to receive fasteners for mounting the second attachment member 80 to the upper die element 24. As such, the first attachment member 62 and the second attachment member 80 may be mounted adjacent one another to separate wires of the first plurality of wires 64 and the second plurality of wires 65. Each of the attachment members may be removably attached to the upper die element 24 or the lower die element 26 so that various attachment members with various numbers of wire cutouts may be utilized based on wire harness selection.

The apparatus 10 may operate to encapsulate ends of the first plurality of wires 64 and the second plurality of wires 65 at a connection to the electrical connector 66. When the upper die element 24 and the lower die element 26 are in the engaged position, a material, such as a two-component urethane, a resin, or a thermoset resin, may be applied to the wires at connection locations between the wires and the electrical connector 66 and the material may be thermally treated to solidify to hermetically seal the wires at the connection location. For example, the material may be applied to the wires within the cavities via the first channel 42 and the second channel 52. Each of the heater blocks may then be heated to a predetermined temperature selected to solidify the material. Since the wires are positioned within respective wire cutouts and separated from one another, the material may enter the cavities and coat each individual wire. The heat may then operate to solidify the material to form a mold component about the wires at the connection locations.

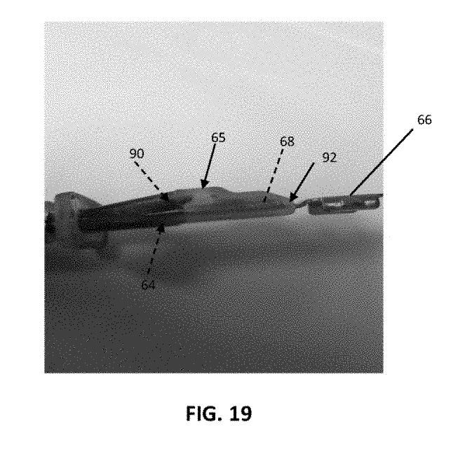

FIG. 19 illustrates an example of the wire bundle apparatus 60 selectively encapsulated in a mold formed from application of the coating material by the apparatus 10. In this example, a mold 90 is shown formed about the first plurality of wires 64 and the second plurality of wires 65. The mold 90 hermetically seals the wires at a connection location 92 between the wires and the electrical connector 66.

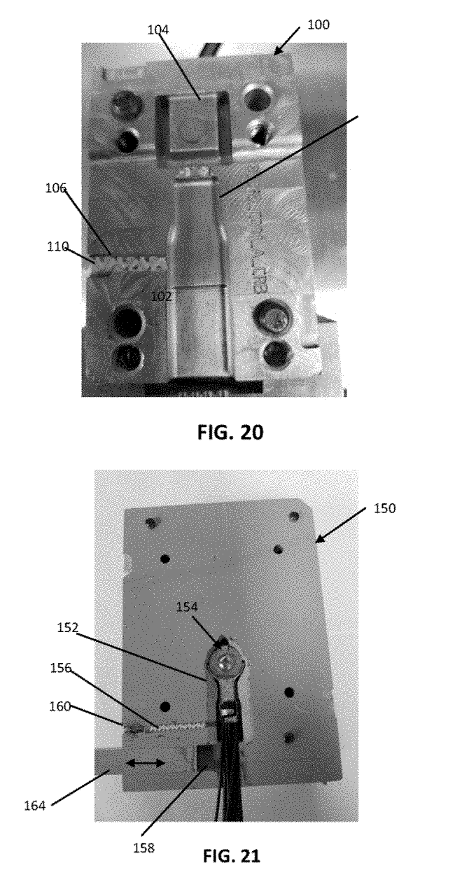

FIG. 20 illustrates an example of a portion of an apparatus in which a lower die element 100 includes a helix insert to assist in mixing material for inserting into a cavity to selectively form a mold about a wire harness apparatus. The lower die element 100 may be a lower component for an apparatus like the lower die element 26 of the apparatus 10. The lower die element 100 may include a wire cavity 102, an electrical connector mount 104, and a channel 106. The wire cavity 102 may be sized to receive a portion of wires of a wire harness apparatus. The electrical connector mount 104 may be sized for mounting an electrical connector, such as an eyelet, thereto. The channel 106 may be open to the wire cavity 102 to operate as a conduit for delivering coating material thereto. The channel 106 may be sized to receive a helix insert 110. Alternatively, the lower die element 100 may be machined to define a helix-shaped channel for delivering the coating material to the wire cavity 102. The helix insert 110 may be shaped to mix the coating material when introduced to the channel 106. For example, a helix shape may assist in ensuring an appropriate mix of a two-component resin. An attachment (not shown in FIG. 20) may be mounted to the lower die element 100 for separating wires of the wire harness apparatus prior to delivery of the coating material.

FIG. 21 illustrates an example of a portion of an apparatus in which a lower die element 150 includes a helix channel and a slider to selectively form a mold about a wire harness. The lower die element 100 may be a lower component for an apparatus like the lower die element 26 of the apparatus 10. The lower die element 100 may include a wire cavity 152, an electrical connector mount 154, a first channel 156, and a second channel 158. The wire cavity 152 may be sized to receive a portion of a wire harness apparatus. The electrical connector mount 154 may be sized for mounting an electrical connector, such as an eyelet, thereto. The first channel 156 may open to the wire cavity 152 to operate as a conduit for delivering coating material thereto. The first channel 156 may be sized to receive a helix insert 160. Alternatively, the lower die element 150 may be machined to define a helix-shaped channel for delivering the coating material to the wire cavity 152. The helix shape may assist in ensuring an appropriate mixture of the coating material.

The second channel 158 may be open to the wire cavity 152 and sized to receive a slider for translation therein. For example, a slider 164 may be disposed within the second channel 158 for translation between at least a first position and a second position to selectively apply pressure to wires of a wire bundle positioned within the wire cavity 152. Applying a pressure to the wire bundle separates the wires from one another such the coating material applied thereto may completely coat each individual wire. Optionally, an attachment (not shown in FIG. 21) may be mounted to the lower die element 150 for separating wires of the wire harness apparatus prior to delivery of the coating material or application of the pressure from the slider 164.

The term upper and lower die elements are used for illustration purposes to correspond to the embodiment in the drawings. These two die elements can have alternative orientations such as side-to-side. The apparatus can be generically described as a first and a second die element defining a mold cavity therebetween when closed. The mold cavity is sized to receive an electrical connector and the end portion of a wire bundle attached to an electrical connector end. The mold has an inlet for introducing a moldable polymeric material into the mold cavity. At least one attachment member is affixed to one of the first and second die elements providing a plurality of wire cutouts each sized to receive the wire bundle and separate each of the wires from one another. One of the first and a second die elements is provided which an inlet for introducing a moldable polymeric material into the mold cavity. The mold cavity has three regions. A first encapsulation cavity region surrounds an attachment portion of the electrical connector into which moldable polymeric material is introduced. A second conductor region sized to receive a conductor portion of the electrical connector and the affixed ends of the wire bundle into which moldable polymeric material does not flow. A third attachment region formed by the at least one attachment member which restricts the flow of moldable polymeric material out of the mold cavity about the wire bundle.

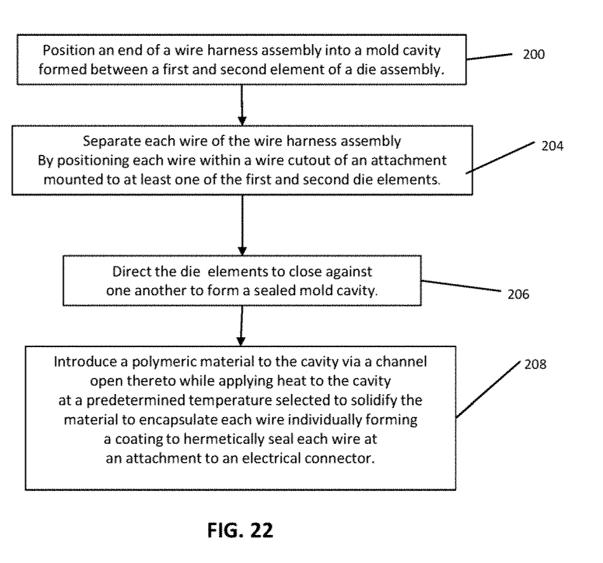

FIG. 22 is a flow chart illustrating an example of a method to selectively coat a portion of a wire harness with a mold at a connection location between wires and an electrical connector. In operation 200, a wire harness apparatus may be positioned within a cavity, such as the first cavity 40, of a lower die element or a lower die element of an apparatus, such as the lower die element 26. In operation 204, each of the wires of the wire harness apparatus may be separated and positioned within a wire cutout, such as the wire cutouts 82 as described above. In operation 206, the first and second elements may be directed to compress against one another and seal the wire harness therebetween. In operation 208, a material, such as the material coating described above, may be supplied to the cavity while heating at a predetermined temperature to solidify the material coating. The wire harness may be arranged within the cavity such that the material coating supplied encapsulates each wire individually and forms a coating about each wire to create a hermetical seal. As such, the wires are each protected to prevent a capillary effect of water migrating into the wire strands and driving corrosion.

The method for selectively coating the end portions of a plurality of wires attached to an electrical connector can be more generically described as provided. The method comprises providing a first and a second die element defining a mold cavity therebetween when closed. The mold cavity is sized to receive an electrical connector and the end portion of a wire bundle attached to an electrical connector end. The mold has an inlet for introducing a moldable polymeric material into the mold cavity. The electrical connector attached to the end portion of a wire bundle into the mold cavity is introduced into the mold. The wires in the wire bundle are positioned in a plurality of wire cutouts in an attachment member connected to one of the die elements with the cutouts sized to receive the wires forming the wire bundle. A conductor region of the electrical connector is attached to a conductor portion of the mold cavity. The mold is then closed and a flowable polymeric material is introduced into an encapsulation cavity portion of the mold cavity to surround the end portion of a wire bundle and an attachment region of the electrical connector. The polymeric material is restricted from flowing into the conductor portion of the mold cavity or past the wires held in the attachment member. After the polymeric material has solidified, the mold cavity is opened and the encapsulated electrical connector attachment region and end portion of a wire bundle is removed.

While various embodiments are described above, it is not intended that these embodiments describe all possible forms encompassed by the claims. The words used in the specification are words of description rather than limitation, and it is understood that various changes can be made without departing from the spirit and scope of the disclosure. The term upper and lower die elements are used to correspond to the embodiment in the drawings. The two die elements can have alternative orientation, such as side-to-side, and the terms upper and lower are not limiting.

As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to marketability, appearance, consistency, robustness, customer acceptability, reliability, accuracy, etc. As such, embodiments described as less desirable than other embodiments or prior art implementations with respect to one or more characteristics are not outside the scope of the disclosure and can be desirable for particular applications.

What is claimed is:

1. An apparatus for selectively coating an end portion of a wire bundle attached to an electrical connector, the apparatus comprising:
a first and a second die element defining a mold cavity therebetween when closed, the mold cavity sized to receive an electrical connector and the end portion of a wire bundle attached to an electrical connector end, and having an inlet for receiving a moldable polymeric material; and
at least one attachment member affixed to one of the first and second die elements including a plurality of wire cutouts each sized to receive the wire bundle and separate each of the wires from one another;
wherein one of the first and a second die elements are provided which an inlet for introducing a moldable polymeric material into the mold cavity;
wherein the mold cavity has three regions, an encapsulation cavity region surrounding an attachment portion of the electrical connector into which moldable polymeric material is introduced; a conductor region sized to receive a conductor portion of the electrical connector and the affixed ends of the wire bundle into which moldable polymeric material does not flow, and an attachment region formed by the at least one attachment member which restricts the flow of moldable polymeric material out of the mold cavity about the wire bundle.

2. The apparatus of claim 1, wherein at least one attachment member comprises two cooperating attachment members connected to the first and a second die elements.

3. The apparatus of claim 1, wherein the conductor region of the mold cavity is provided with a fastener for securely attaching the conductor portion of the electrical connector to one of the die elements.

4. The apparatus of claim 1, further comprising at least one heater cooperating with the first and a second die element to heat the mold cavity to cause the moldable polymeric material to encapsulate the attachment portion of the electrical connector and associated wire bundle ends.

5. The apparatus of claim 1, further comprising: a toggle clamp mechanism attached to at least one of the first and a second die elements to open and close the mold cavity.

6. An apparatus for selectively coating a portion of a wire bundle apparatus comprising:
a base member;
a vertical member extending from the base member;
a horizontal member mounted to the vertical member for translation between at least a first position and a second position;
a clamp apparatus including a upper die element mounted to the horizontal member and a lower die element mounted to the base member defining a cavity therebetween having an inlet for receiving moldable polymeric material; and
an attachment member including wire cutouts and mounted to the lower die element such that the wire cutouts are in substantial registration with the cavity,
wherein the wire cutouts are arranged with the cavity to separate wires of a wire apparatus disposed therein such that a coating material introduced within the cavity fully coats each of the wires when the horizontal member is in the second position.

7. The apparatus of claim 6, further comprising a heater cooperating with the inlet for receiving moldable polymeric material

8. A method of selectively coating the end portions of a plurality of wires attached to an electrical connector, the method comprising:
providing a first and a second die element defining a mold cavity therebetween when closed, the mold cavity sized to receive an electrical connector and the end portion of a wire bundle attached to an electrical connector end;
introducing an electrical connector attached to the end portion of a wire bundle into the mold cavity;
positioning the wires in the wire bundle in a plurality of wire cutouts in an attachment member connected to one of the die elements, where the cutouts are sized to receive the wires forming the wire bundle;
securing a conductor region of the electrical connector into a conductor portion of the mold cavity;
introducing an flowable polymeric material into an encapsulation cavity portion of the mold cavity which surrounds the end portion of a wire bundle and an attachment region of the electrical connector, while restricting the flow of polymeric material into the conductor portion of the mold cavity or past the wires held in the attachment member; and
after the polymeric material has solidified, opening the mold cavity and removing the encapsulated electrical connector attachment region and end portion of a wire bundle.

9. The method of claim 8, wherein the flowable material introduced into the mold cavity is a thermoplastic.

10. The method of claim 8, wherein the flowable thermoplastic introduced into the mold cavity is a reaction injection molded polymer.

11. The method of claim 8 wherein securing a conductor region of the electrical connector comprises securely attaching the conductor portion of the electrical connector to one of the die elements to center the electrical connector with the mold cavity when the mold is closed.

12. The method of claim 8 further comprising heating the mold cavity prior to introducing the flowable material introduced into the mold cavity.
